(19) United States
(12) Patent Application Publication
(10) Pub. No.: US 2014/0176501 A1
(43) Pub. Date: Jun. 26, 2014

(54) NON-TOUCH CONTROL SYSTEM

(71) Applicant: Industrial Technology Research Institute, Hsinchu (TW)

(72) Inventor: Jian-Chiun Liou, Kaohsiung City (TW)

(73) Assignee: Industrial Technology Research Institute, Hsinchu (TW)

(21) Appl. No.: 13/900,549

(22) Filed: May 23, 2013

(30) Foreign Application Priority Data
Dec. 21, 2012 (TW) 101149165

(51) Int. Cl. G06F 3/042

(52) U.S. Cl. CPC G06F 3/0421
USPC 345/175

(57) ABSTRACT

A non-touch control system is provided. The non-touch control system comprises an object sensing module and a control interface module. The object sensing module comprises a plurality of object transmitting-receiving pairs which set along a plurality of directions to define a sensing space. The sensing space comprises a virtual plane. The object sensing module is used for sensing an object which enters the sensing space and determines whether the object touches the virtual plane. The control interface module provides an operational interface. The virtual plane comprises a plurality of sub-regions respectively corresponding to a plurality of operational blocks of the operational interface. When the object touches one of the sub-regions, the object transmitting-receiving sensing pair corresponding to the sub-region transfers a first sensing signal to the control interface module after a delay time, in order to execute the function of the operating block corresponding to the sub-region.

### CROSS-REFERENCE TO RELATED APPLICATION

This application claims the priority benefit of Taiwan application serial no. 101149165, filed on Dec. 21, 2012. The entirety of the above-mentioned patent application is hereby incorporated by reference herein and made a part of this specification.

### BACKGROUND

1. Technical Field

The disclosure generally relates to a non-touch control system.

2. Related Art

A traditional key system is usually operated by touching which may cause pollutions and breeding of germs. With the development of touch sensing technology, the technology of multi-touch operation has gradually been used in all kind of daily necessities widely. For various touch devices which become popular, it is necessary to enter texts by a non-touch control system in the daily life of the future.

In the current non-touch control system, an infrared sensing array arranged in matrix and formed by an infrared transmitting-receiving module is usually applied to locate the position of an object by interrupting the infrared ray. However, in the current sensing mechanism of the infrared transmitting-receiving module, the infrared transmitting-receiving module continuously determines the corresponding position being touched since the object interrupts the infrared ray, and thereby it often lead to the erroneous operation which continuously triggers the same key. Hence, it is not convenient for users.

### SUMMARY

The disclosure provides a non-touch control system which comprises an object sensing module and a control interface module. The object sensing module comprises a plurality of object transmitting-receiving sensing pairs arranged along a plurality of different directions to define a sensing space. The sensing space comprises a virtual plane. The object sensing module is configured to sense an object which enters the sensing space and determine whether the object touches the virtual plane. The control interface module is electrically connected to the object sensing module and is configured to provide an operational interface, wherein the virtual plane comprises a plurality of sub-regions. The sub-regions are respectively corresponding to a plurality of operational blocks of the operational interface. When the object touches one of the sub-regions, the object transmitting-receiving sensing pairs corresponding to the sub-region being touched transmits a first sensing signal to the control interface module after a delay time, such that the control interface module executes an operational function of the operational block corresponding to the sub-region being touched.

The disclosure provides a non-touch control system which comprises an object sensing module, a control interface module and, an image generating module. The object sensing module comprises a plurality of object transmitting-receiving sensing pairs arranged along a plurality of different directions to define a sensing space. The sensing space comprises a virtual plane. The object sensing module is configured to sense an object which enters the sensing space and determine whether the object touches the virtual plane. The control interface module is electrically connected to the object sensing module and is configured to provide an operational interface. The image generating module is configured to generate an interface image corresponding to the operational interface on the virtual plane. The interface image comprises a plurality of sub-regions, the sub-regions are respectively corresponding to a plurality of operational blocks of the operational interface. When the object touches one of the sub-regions, the object transmitting-receiving sensing pairs corresponding to the sub-region being touched transmit a first sensing signal to the control interface module after a delay time for executing an operational function of the operational block corresponding to the sub-region being touched.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view illustrating a non-touch control system according to an embodiment of the disclosure.

FIG. 2 is a schematic view illustrating an object sensing module according to an embodiment of the disclosure.

FIG. 3 is a schematic circuit of the object sensing module according to an embodiment of the disclosure.

FIG. 4 is a schematic view illustrating an object transmitting-receiving sensing pair according to an embodiment of the disclosure.

FIG. 5 is a schematic view illustrating delay unit sets and a synchronous processing unit according to an embodiment of the disclosure.

FIG. 6 is a schematic view illustrating a timing sequence of enable signals according to the embodiment of FIG. 5.

FIG. 7 is a schematic view illustrating delay unit sets and a synchronous processing unit according to another embodiment of the disclosure.

FIG. 8 is a schematic view illustrating a timing sequence of enable signals according to the embodiment of FIG. 7.

FIG. 9 is a schematic view illustrating a non-touch control system according to another embodiment of the disclosure.

FIG. 10 is a schematic view illustrating a multi-view image device according to an embodiment of the disclosure.

### DETAILED DESCRIPTION OF DISCLOSED EMBODIMENTS

The exemplary embodiment of the disclosure introduces a non-touch control system that operates and controls a key system without contacting. Therefore, wastages and pollutions of the key system due to contacting can be avoided. In addition, the non-touch control system further provides a sensing mechanism which can prevent the key system from being inadvertently touched, and thus the operational accuracy of the key system can be enhanced. In order to make the disclosure more comprehensible, embodiments are described below as examples to prove that the disclosure can actually be realized. Moreover, elements/components/steps with same reference numerals represent same or similar parts in the drawings and embodiments.

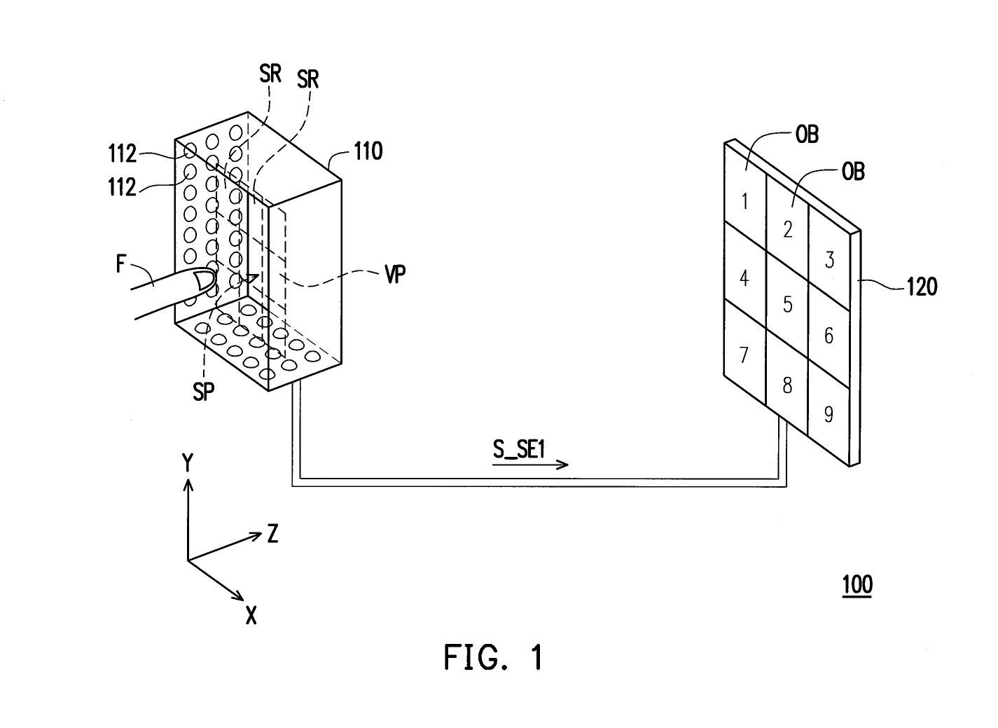

FIG. 1 is a schematic view illustrating a non-touch control system according to an embodiment of the disclosure. With reference to FIG. 1, the non-touch control system 100 comprises an object sensing module 110 and a control interface module 120. The object sensing module 110 comprises a plurality of object transmitting-receiving sensing pairs 112, wherein the object transmitting-receiving sensing pairs 112 in the object sensing module 110 are arranged in a plurality of different directions to define a sensing space SP. Herein, the object transmitting-receiving sensing pairs are illustrated for reference in order to make the figure more clearly, but the disclosure is not limited thereto. The following embodiments will further describe the structure of the object transmitting-receiving sensing pairs.

In the present embodiment, the sensing space SP comprises a virtual plane VP. The object sensing module 110 can be configured to sense an object which enters the sensing space SP and determine whether the object touches the virtual plane or not. According to the present embodiment, if the object transmitting-receiving sensing pairs 112 are the optical sensing element as illustrated in FIG. 1, a transmitting module and a receiving module of the object transmitting-receiving sensing pairs 112 are respectively disposed on both sides which are corresponding to each other, such that the light or signals transmitted by the transmitting module can be received by the opposite receiving module. Hence, when a finger is put into the sensing space SP and thus interrupts the light or signals transmitted by the transmitting module, the receiving module calculates the position of the finger because of without receiving the light or signals.

The control interface module 120 is electrically connected to the object sensing module 110, and is configured to provide an operational interface which can be controlled by users, e.g., a keyboard system. The virtual plane VP comprises a plurality of sub-regions SR which are corresponding to the operation interface of the control interface module 120 respectively. When one of the sub-regions SR is touched by the object, the object transmitting-receiving sensing pair 112 corresponding to the sub-region SR being touched transmits the sensing signal S_SE1 to the control interface module 120, such that the control interface module 120 executes an operational function of the operational block OB corresponding to the sub-region SR being touched.

For instance, the control interface module 120 can provide the operational interface of a number pad with 3 by 3 grid. When the users touch the sub-region SR, which is corresponding to the button “1” of the number pad, on the virtual plane VP by the finger F, the corresponding object transmitting-receiving sensing pair 112 senses the position of the finger F and transmits the corresponding sensing signal S_SE1 to the control interface module 120, such that the control interface module 120 triggers button “1”.

To be specific, the control interface module 120 mainly provides an interface which can display specific literals or images, such that the users can operate the interface according to the literals or images. In more details, the control interface module 120 can provide the operational interface with different functions and forms, e.g., the number pad with 3 by 3 grid, a telephone keypad, an elevator keypad, a password keypad or other forms of keypad interfaces.

Furthermore, the control interface module 120 of the present embodiment can further comprise a flat panel display for displaying a flat image corresponding to the operational interface. The flat panel display can be a self-illuminating display panel, e.g., organic electroluminescent display panels, and the self-illuminating display panel can display the specific literals or images according to the practical applications, e.g., the number pad with 3 by 3 grid, a telephone keypad, an elevator keypad, a password keypad or other forms of keypad interface.

In addition, the control interface module 120 can also comprise a non-self-illuminating display panel (not shown) and a back light module (not shown). The non-self-illuminating display panel can be a liquid crystal display panel. The back light module provides a light source required by the display panel, such that the display panel can display an image corresponding to the operational interface. In the present embodiment, the back light module can be a direct back light module or an edge back light module. Similarly, the display panel can display the specific literals or images according to the practical applications, e.g., the number pad with 3 by 3 grid, a telephone keypads, an elevator keypad, a password keypad or other forms of keypad interfaces.

Moreover, the control interface module 120 can also comprises a light source and a transparent mask (not shown) corresponding to the image of the operational interface. The transparent mask comprises a transparent region and a non-transparent region, and the transparent region comprises an image corresponding to the operational interface. In other words, the transparent mask comprising the image corresponding to the operational interface can display the specific literals or images according to the practical applications, e.g., the number pad with 3 by 3 grid, a telephone keypad, an elevator keypad, a password keypad or other forms of keypad interfaces. The transparent mask can project the illuminated specific literals or images corresponding to the operational interface when the lights of the light source pass through the transparent region.

Furthermore, the control interface module 120 can also comprise a stereo display which is configured to display a stereo image corresponding to the operational interface and appeared in the sensing space SP, such that the users can operate the control interface module 120 by touching the stereo image. The stereo display can be a multi-view stereo display comprising a display panel, a lens film and a plurality of light bars, wherein in which the light bars are lighted in sequence such that a parallax image is displayed on the display panel through the lens film for generating the stereo image with multi-view.

No matter what forms of the foregoing control interface module 120, the users had to operate the control interface module 120 with contacting (i.e., directly press or touch the control interface module) in the past, which may lead the problems of dirt accumulation, bacteria pollution, and wastage of the key system. In the non-touch control system 100 of the present exemplary embodiment, the users can operate the control interface module 120 by touching the virtual plane VP, which means the users do not have to operate the control interface module by directly contacting the control interface module 120.

In the present embodiment, the object sensing module 110 transmits the sensing signal S_SE1 to the control interface module 120 through wired or wireless communication. For instance, the object sensing module 110 can be electrically connected to the control interface module 120 through a universal serial bus (USB) transmitting apparatus, a Bluetooth transmitting apparatus or a radio frequency identification (RFID) transmitting apparatus, such that the object sensing module 110 transmits the sensing signal S_SE1 accordingly. However, the disclosure is not limited thereto.

However, in the situation of operating the control interface module 120 through the object sensing module 110, since the corresponding area on the virtual plane VP is touched by the user's finger F, the corresponding object transmitting-receiving sensing pairs 112 continuously transmit the sensing signal S_SE1 to the control interface module 120 when the virtual plane is touched, and thus the same operational function of the control interface module 120 may be continuously triggered, which is deemed as an erroneous operation. On other hand, in the general sensing mechanism, the object sensing module 110 cannot identify the touch event if two of the sub-regions SR are simultaneously touched by the users inadvertently, and the control interface module 120 may therefore simultaneously trigger the operational functions corresponding to the two sub-regions SR, which is also deemed as an erroneous operation.

Besides, in general sensing mechanism of the object sensing module 110, the signals between the object transmitting-receiving sensing pairs 112 and the adjacent object transmitting-receiving sensing pairs 112 must be adjusted to have different wavelength in order to avoid the signals transmitted from the object transmitting-receiving sensing pairs 112 being affected by the signals transmitted from the adjacent object transmitting-receiving sensing pairs 112. Therefore, the overall object sensing module 110 must be designed to have a wider wavelength modulation range, and it may enhance the difficulties of design.

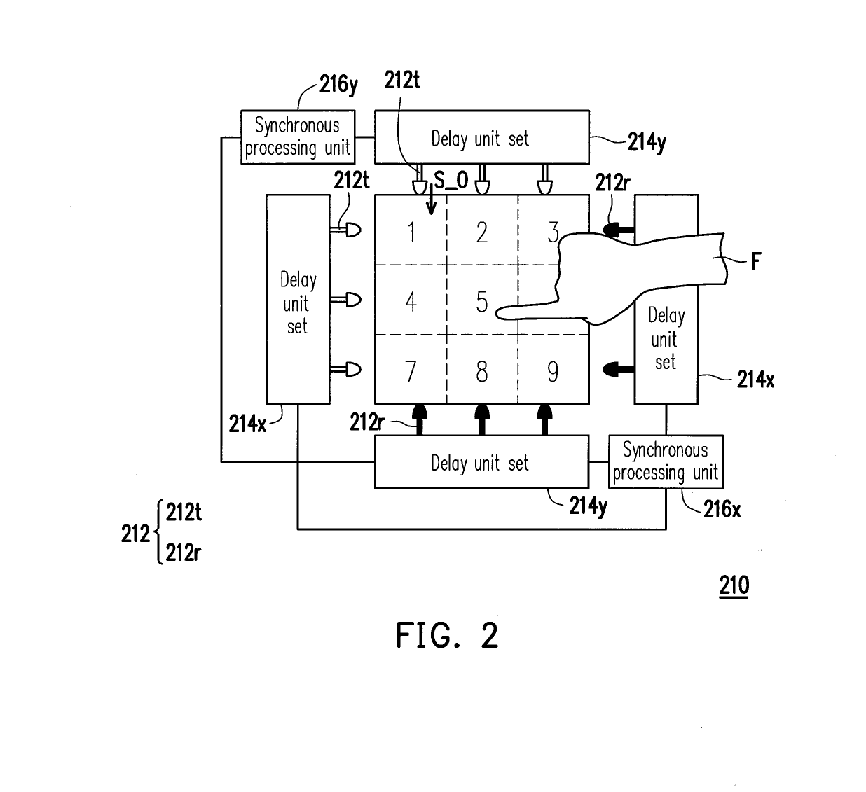

To further enhance the touch sensing accuracy of the non-touch control system, the disclosure introduces a structure of the object sensing module as shown in FIG. 2 which can provide the non-contact touch sensing mechanism with more accuracy. FIG. 2 is a schematic view illustrating an object sensing module according to an embodiment of the disclosure.

With reference to FIG. 2, the object sensing module 210 comprise a plurality of transmitting-receiving sensing pairs 212, a plurality of delay unit sets 214x and 214y, and a plurality of synchronous processing units 216x and 216y. In the present embodiment, each of the object transmitting-receiving sensing pairs 212 comprises a transmitting module 212t and a receiving module 212r. The transmitting module 212t is configured to transmit an object sensing signal S_O, and the receiving module 212r is configured to output the sensing signal S_SE1 according to the object sensing signal S_O transmitted from the corresponding transmitting module 212t. The delay unit sets 214x and 214y are respectively electrically connected to the corresponding object transmitting-receiving sensing pairs 212 for delaying signal transmission of the object transmitting-receiving sensing pairs 212. The synchronous processing units 216x and 216y are respectively electrically connected to the delay units sets 214x and 214y corresponding to the object transmitting-receiving sensing pairs 212 arranged along the same direction, and the synchronous processing units 216x and 216y are configured to synchronously control each of the delay unit sets to set the delay time which delays the transmission of the sensing signal S_SE1 of each of the object transmitting-receiving sensing pairs 212. In the present embodiment, the configuration of the transmitting module 212t and the receiving module 212r disposed in one object transmitting-receiving sensing pair 212 is not limited to be arranged in one-to-one correspondence. In each of the transmitting-receiving sensing pairs 212, a single transmitting module 212t can correspond to plural receiving modules 212r, and the disclosure is not limited thereto.

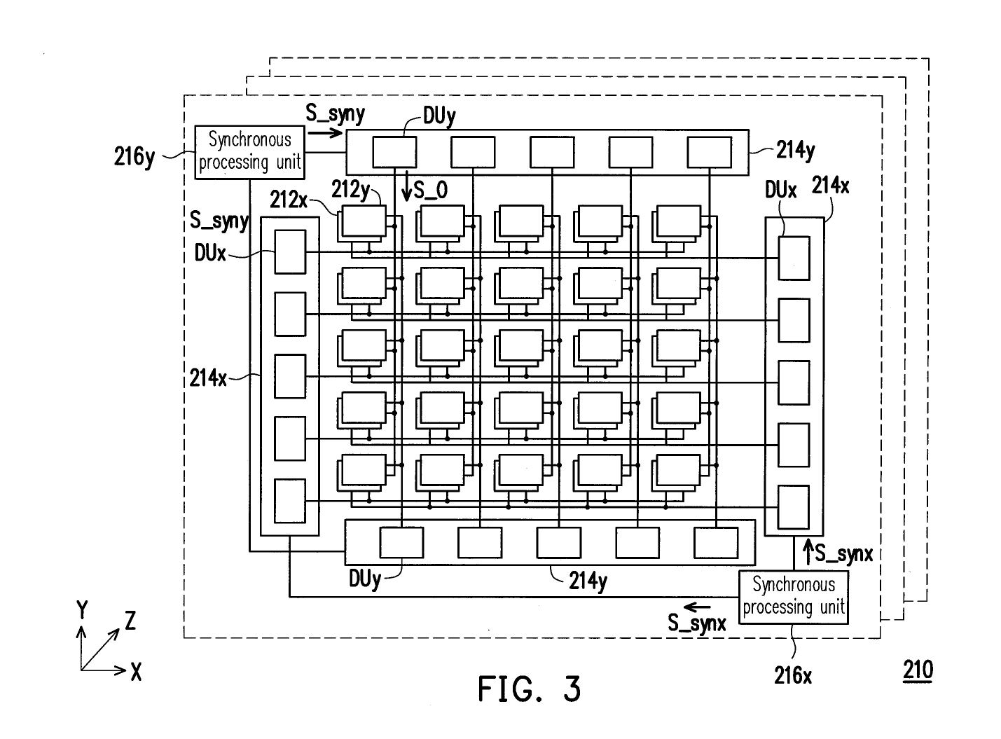

To further describe the structure of the object sensing module, FIG. 3 is a schematic circuit of the object sensing module according to an embodiment of the disclosure. In the present embodiment, the object transmitting-receiving sensing pairs 212x and 212y of the object sensing module 210 are correspondingly arranged on the XY-plane, and the object transmitting-receiving sensing pairs 212x and 212y arranged on the XY-plane are sequentially arranged in along Z-axis to constitute an array configuration of three-dimensional, such that the sensing space having depth, e.g., the sensing space SP, can be defined. Additionally, the virtual plane, e.g., the virtual plane VP, can be one of the XY-planes which constitutes the sensing space. In other words, the depth position of the virtual plane in the sensing space, i.e., the coordinate on Z-axis, can be designed according to the design requirement, and the disclosure is not limited thereto.

Herein, the equivalent circuit diagram of the object transmitting-receiving sensing pairs 212x and 212y sequentially arranged along Z-axis are schematically illustrated on the same plane. In the present embodiment, the object transmitting-receiving sensing pairs 212x are sequentially arranged along Y-axis and are configured to build a plurality of sensing paths along X-axis in which the object transmitting-receiving sensing pairs 212x illustrated in a row represent the object transmitting-receiving sensing pairs arranged along Z-axis. The object transmitting-receiving sensing pairs 212y are sequentially arranged along X-axis and are configured to build the sensing paths along Y-axis in which the object transmitting-receiving sensing pairs 212y illustrated in a column represent the object transmitting-receiving sensing pairs arranged along Z-axis.

In details, the delay unit sets 214x and 214y respectively comprise a plurality of delay units DUx and DUy. The delay units DUx and DUy are electrically connected the corresponding object transmitting-receiving sensing pairs 212x and 212y, respectively. As to the object transmitting-receiving sensing pairs 212x arranged along the Y-axis, the synchronous processing units 216x output the synchronous signal S_synx to the delay unit sets 214x, such that the delay units DUx sequentially enable the object transmitting-receiving sensing pairs 212x according to the synchronous signal S_synx during the preset delay time to define the Y-coordinate of the object in the sensing space.

Similarly, as to the object transmitting-receiving sensing pairs 212y, the synchronous processing units 216y output the synchronous signal S_syny to the delay unit sets 214y, such that the delay units DUy sequentially enable the object transmitting-receiving sensing pairs 212x according to the synchronous signal S_syny during the preset delay time to define the X-coordinate of the object in the sensing space.

According to the aforementioned sensing mechanism, the object transmitting-receiving sensing pairs 212x and 212y on an identical plane can define the coordinates on the plane in the sensing space, and thereby the coordinates of the sensing space can further be defined by the object transmitting-receiving sensing pairs 212x and 121y arranged along Z-axis, such that the object sensing module 210 can determine whether the object touches the virtual plane or not.

To be specific, since the object entering the sensing space is detected after the object transmitting-receiving sensing pairs 212x and 212y are enabled, the object transmitting-receiving sensing pairs 212x and 212y determine whether the virtual plane is touched or not again, and accordingly transmit the sensing signal to the control interface module after the preset delay time. In other words, the operational function is not triggered even if the finger continuously touches the corresponding sub-region on the virtual plane during the preset delay time.

On the other hand, the object sensing module 210 of the present embodiment determines whether to output the sensing signal to trigger the corresponding operational function by comparing the sensing status between the adjacent object transmitting-receiving sensing pairs 212x and 212y. For instance, with reference to FIG. 2 again, when a user's finger simultaneously touches the adjacent sub-regions on the virtual plane, e.g., the sub-region between the button “1” and the button “2”, the corresponding object transmitting-receiving sensing pairs 212x and 212y prohibit the sensing signal from being transmitted to the control interface module, e.g., the control interface module 120, under the conduction that the adjacent object transmitting-receiving sensing pairs 212x and 212y simultaneously sense the corresponding sub-regions being touched.

Additionally, in the present embodiment, the object transmitting-receiving sensing pairs 212x and 212y can be further electrically connected to an electrostatic discharge (ESD) protection element (not shown) correspondingly, such that the object transmitting-receiving sensing pairs 212x and 212y can be prevented from being affected by ESD phenomenon, and thus the circuit stability of the object sensing module 210 can be enhanced, but the disclosure is not limited thereto.

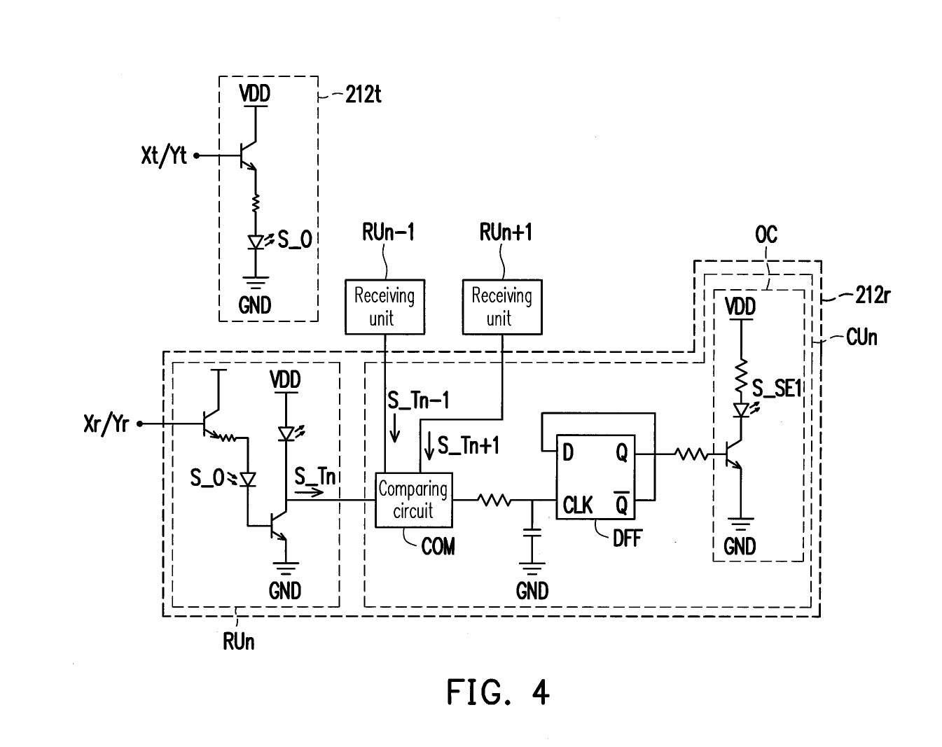

FIG. 4 is a schematic view illustrating an object transmitting-receiving sensing pair according to an embodiment of the disclosure. With reference to FIG. 4, the object transmitting-receiving sensing pair 212 comprises the transmitting module 212t and the receiving module 212r. The transmitting module 212t and the receiving module 212r are respectively electrically connected to the corresponding delay units DUy via nodes Yt and Yr if the object transmitting-receiving sensing pair 212 are arranged along X-axis, e.g., the object transmitting-receiving sensing pairs 212y, and the transmitting module 212t and the receiving module 212r are respectively electrically connected to the corresponding delay units DUx via nodes Xt and Xr if the object transmitting-receiving sensing pair 212 are arranged along Y-axis, e.g., the object transmitting-receiving sensing pairs 212x.

The receiving module 212r comprises a receiving unit RUn and a comparing unit CUn. The receiving unit RUn is configured to receive the object sensing signal S_O and output a touch signal S_T accordingly. The comparing unit CUn is electrically connected to the receiving unit RUn and the receiving units RUn−1 and RUn+1 of the adjacent receiving modules for comparing the touch signal S_Tn outputted from the receiving unit RUn with the touch signals S_Tn−1 and S_Tn+1 outputted from the receiving units RUn−1 and RUn+1, thereby generating and outputting the sensing signal S_SE1. In the present embodiment, the comparing unit CUn can be realized by the circuit structure constituted by the comparing circuit COM, the D flip-flop DFF and the output circuit OC, but the disclosure is not limited thereto.

To be specific, after the object transmitting-receiving sensing pair 212 is enabled by the corresponding delay unit, the receiving unit RUn detects the position of the object in the sensing space according to whether the receiving unit RUn receives the object sensing signal S_O outputted from the corresponding transmitting module 212t. For instance, the receiving unit RUn receives the corresponding object sensing signal S_O if the sensing path between the transmitting module 212t and the receiving module 212r is not interrupted by any object, such that the receiving unit RUn outputs the touch signal S_Tn being disabled. On the contrary, if the sensing path between the transmitting module 212t and the receiving module 212r is interrupted, the receiving unit RUn outputs the touch signal S_Tn being enabled since the receiving unit RUn does not receive the object sensing signal S_O.

The comparing circuit COM of the comparing unit CUn compares the enabled touch signal S_Tn with the touch signals S_Tn−1 and S_Tn+1 respectively outputted from the adjacent receiving unit RUn−1 and RUn+1 when the receiving unit RUn does not receive the object sensing signal S_O which means the sensing path is interrupted by the object. If the comparing circuit COM determines the touch signal S_Tn is enabled, and the touch signal S_Tn−1 and S_Tn+1 are disabled, which means no erroneous operation happens since the adjacent sub-regions on the virtual plane are not simultaneously touched, the comparing circuit COM generates an enabled signal as a clock input of the D flip-flop DFF, so as to control the output circuit OC to output the sensing signal S_SE1 accordingly. On the other hand, if the comparing circuit COM determines the touch signal S_Tn, and the touch signals STn−1 or STn+1 are simultaneously enabled, which means an erroneous operation happens since the adjacent sub-regions on the virtual plane are simultaneously touched, the comparing circuit COM generates a disabled signal as the clock input of the D flip-flop DFF, so as to control the output circuit OC to prohibit the sensing signal S_SE1 from being transmitted according to the output signal outputted from the D flip-flop DFF.

In other words, the comparing unit CUn determines whether the touch signals outputted from the receiving unit RUn and outputted from the adjacent receiving unit RUn−1 or RUn+1 are simultaneously enabled. If the touch signals outputted from the receiving unit RUn and outputted from the adjacent receiving unit RUn−1 or RUn+1 are simultaneously enabled, the comparing unit CUn prohibits the sensing signal S_SE1 from being transmitted to prevent the unexpected operational functions from being triggered.

In the present embodiment, the adjacent receiving units is not limited to the receiving unit RUn−1 and RUn+1 which are disposed on the both side nearest to the receiving unit RUn. The comparing unit CUn can also determine whether the inadvertent touch event is occurred by comparing the touch signals outputted from the receiving unit RUn with the plural adjacent receiving units, but the disclosure is not limited thereto.

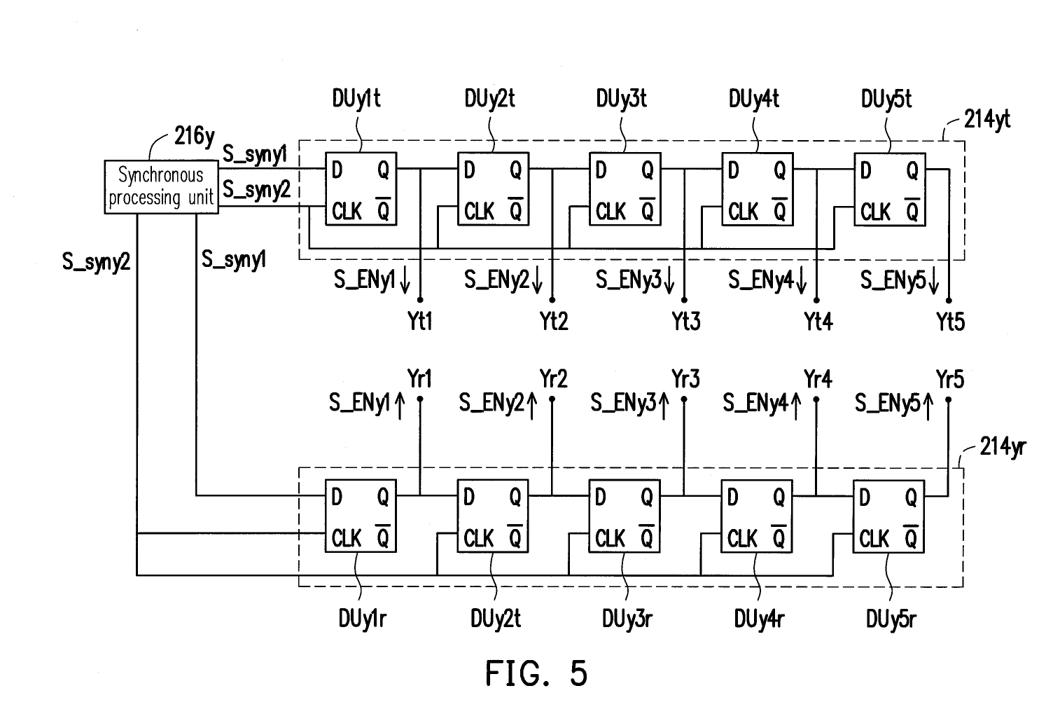

FIG. 5 is a schematic view illustrating delay unit sets and a synchronous processing unit according to an embodiment of the disclosure. In the present embodiment, the delay unit sets 214yt and 214yr and the synchronous processing 216y are corresponding to the object transmitting-receiving sensing pairs arranged along X-axis and configured to build the sensing paths along Y-axis, e.g., the object transmitting-receiving sensing pairs 212y. With reference to FIG. 5, the delay unit sets 214yt and 214yr respectively comprise a plurality of delay units DUy1t to DUy5t and DUy1r to DUy5r. The delay units DUy1t to DUy5t and DUy1r to DUy5r are implemented by the circuit structure constituted by the D flip-flop, but the disclosure is not limited thereto.

In the present embodiment, the delay unit set 214yt is electrically connected to the transmitting module, e.g., the transmitting module 212t, of the corresponding object transmitting-receiving sensing pairs, e.g., the object transmitting-receiving sensing pairs 212, via nodes Yt1 to Yt5, respectively. The delay unit set 214yr is electrically connected to the receiving module, e.g., the receiving module 212r, of the corresponding object transmitting-receiving sensing pairs, e.g., the object transmitting-receiving sensing pairs 212. The delay unit DUy1t and DUy1r are corresponding to one set of the object transmitting-receiving sensing pair, the delay unit DUy2t and DUy2r are corresponding to another set of the object transmitting-receiving sensing pair, and so on. Specifically, the input terminal of the delay unit DUy1t is coupled to the synchronous processing unit 216y, the output terminals of the delay units DUy1t to DUy5t are respectively electrically connected to the input terminals of the next stage delay units DUy1t to DUy5t, and the clock inputs of each delay units DUy1t to DUy5t are coupled to the synchronous processing unit 216y. Besides, the connection relations of the delay units DUy1r to DUy5r may be referred to as that of the delay units DUy1t to DUy5t and thus will not be further described herein. In other words, the circuit configuration of the delay unit sets 214yt and 214yr are similar to the shift register of serial-in-serial-out.

To be specific, the delay unit sets 214yt and 214yr are controlled by the synchronous processing unit 216y, such that the delay units DUy1t to DUy5t and DUy1r to DUy5r output enable signals S_ENy1 to S_ENy5 in sequence according to the edge trigger characteristic of the D flip-flop. The delay units, e.g., the delay unit DUy1t and DUy1r, corresponding to the same set of the object transmitting-receiving sensing pair, e.g., the object transmitting-receiving sensing pair 212, output the corresponding enable signal, e.g., the enable signal S_ENy1, such that the transmitting module and the receiving module of each set of the object transmitting-receiving sensing pairs can be enabled correspondingly.

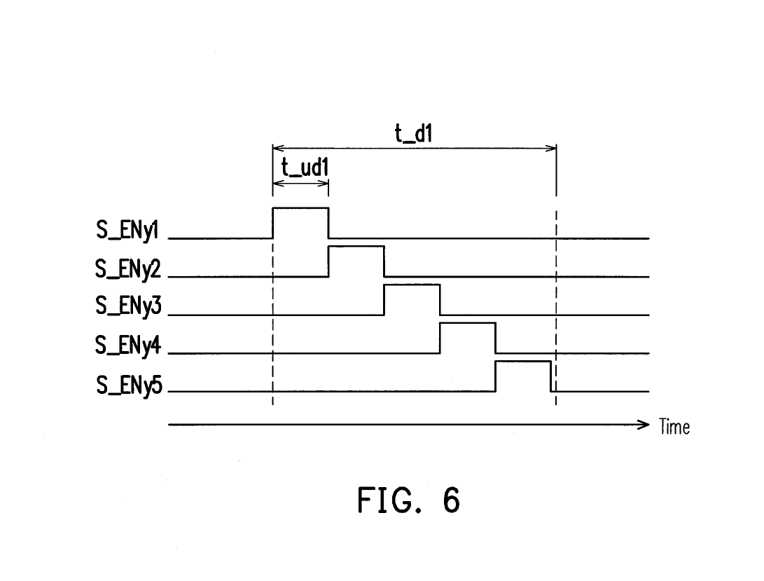

According to the circuit configuration of the delay unit sets 214yt and 214yr, the waveform of the enable signals S_ENy1 to S_ENy5 are schematically illustrated in FIG. 6. With reference to FIG. 5 and FIG. 6, the delay units DUy1t to DUy5t and DUy1r to DUy5r are triggered in sequence when the enable signals S_ENy1 to S_ENy5 outputted from the previous delay units DUy1t to DUy5t and DUy1r to DUy5r are converted to a low level according to the synchronous signal S_syny2. Take the delay unit set 214yt for example, the delay unit DUy1t outputs the enable signal S_ENy1 with a high level at the beginning of a sensing period according to the synchronous signals S_syny1 and S_syny2, and converts the enable signal S_ENy1 to the low level after the unit delay time t_ud1 during the sensing period. Herein, the delay unit DUy2t outputs the enable signal S_ENy2 with the high level in response to the conversion of the enable signal S_ENy1, and similarly converts the enable signal S_ENy2 to the low level after the unit delay time t_ud1 during the sensing period. Similarly, the delay units DUy3t to DUy5t sequentially output the enable signals S_ENy3 to S_ENy5 with the high level in the same manner as described above. Therefore, the delay unit sets 214yt and 214yr can enable the corresponding object transmitting-receiving sensing pairs in sequence by the enable signals S_ENy1 to S_ENy5 with the high level during the delay time t_d1, such that the sensing mechanism of time-multiplexed can be implemented, and thus the position of the object on X-axis in sensing space can be detected.

In the present embodiment, the timing sequence of the enable signals S_ENy1 to S_ENy5 as shown in FIG. 6 is merely exemplary for description. In other embodiments, the object transmitting-receiving sensing pairs can be enabled in different orders by receiving the enable signals S_ENy1 to S_ENy5 with different timing sequences based on the circuit configuration of the corresponding delay unit sets 216yt and 216yr, and the disclosure is not limited thereto. Furthermore, although the object transmitting-receiving sensing pairs are enabled by the corresponding enable signals S_ENy1 to S_ENy5 with the high level in the present embodiment, the object transmitting-receiving sensing pairs can be enabled by the corresponding enable signals S_ENy1 to S_ENy5 with the low level, and the disclosure is also not limited thereto.

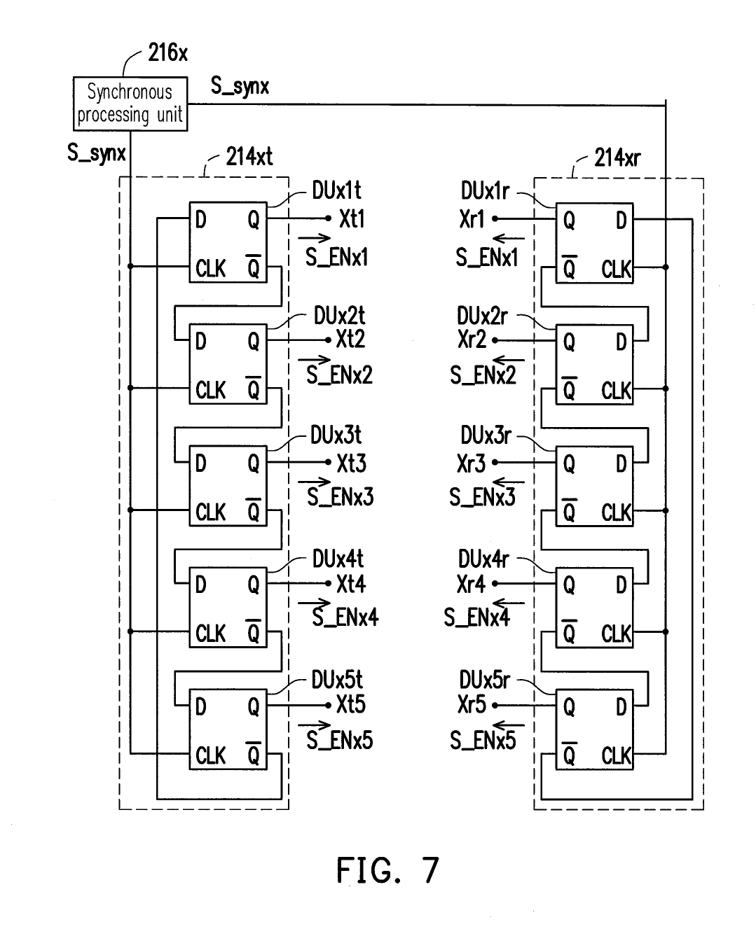

FIG. 7 is a schematic view illustrating delay unit sets and a synchronous processing unit according to another embodiment of the disclosure. In the present embodiment, the delay unit sets 214xt and 214xr and the synchronous processing 216x are corresponding to the object transmitting-receiving sensing pairs arranged along Y-axis and configured to build the sensing paths along X-axis. With reference to FIG. 7, the delay unit sets 214xt and 214xr respectively comprise a plurality of delay units DUx1t to DUx5t and DUx1r to DUx5r. The delay units DUx1t to DUx5t and DUx1r to DUx5r are implemented by the circuit structure constituted by the D flip-flop, but the disclosure is not limited thereto.

In the present embodiment, the delay unit set 214xt is electrically connected to the transmitting module, e.g., the transmitting module 212t, of the corresponding object transmitting-receiving sensing pairs, e.g., the object transmitting-receiving sensing pairs 212, via nodes Xt1 to Xt5, respectively. The delay unit set 214xr is electrically connected to the receiving module, e.g., the receiving module 212r, of the corresponding object transmitting-receiving sensing pairs, e.g., the object transmitting-receiving sensing pairs 212. The delay unit DUx1t and DUx1r are corresponding to one set of the object transmitting-receiving sensing pair, the delay unit DUx2t and DUx2r are corresponding to another set of the object transmitting-receiving sensing pair, and so on. Specifically, the output terminals of the delay units DUx 1t to DUx5t are sequentially electrically connected to the inverting output terminals of the next stage delay units DUy1t to DUy5t, the inverting output terminal of the last stage delay unit DUx5t is coupled to the input terminal of the first stage delay unit DUx1t, and the clock inputs of each delay units DUx1t to DUx5t are coupled to the synchronous processing unit 216x. Besides, the connection relations of the delay units DUx1r to DUx5r may be referred to as that of the delay units DUx1t to DUx5t and thus will not be further described herein.

To be specific, the delay unit sets 214xt and 214xr are controlled by the synchronous processing unit 216x, such that the delay units DUx1t to DUx5t and DUx1r to DUx5r output enable signals S_ENx1 to S_ENx5 in sequence according to the edge trigger characteristic of the D flip-flop. The delay units, e.g., the delay unit DUx1t and DUx1r, corresponding to the same set of the object transmitting-receiving sensing pair, e.g., the object transmitting-receiving sensing pair 212, output the corresponding enable signal, e.g., the enable signal S_ENx1, such that the transmitting module and the receiving module of each sets of the object transmitting-receiving sensing pairs can be enabled correspondingly.

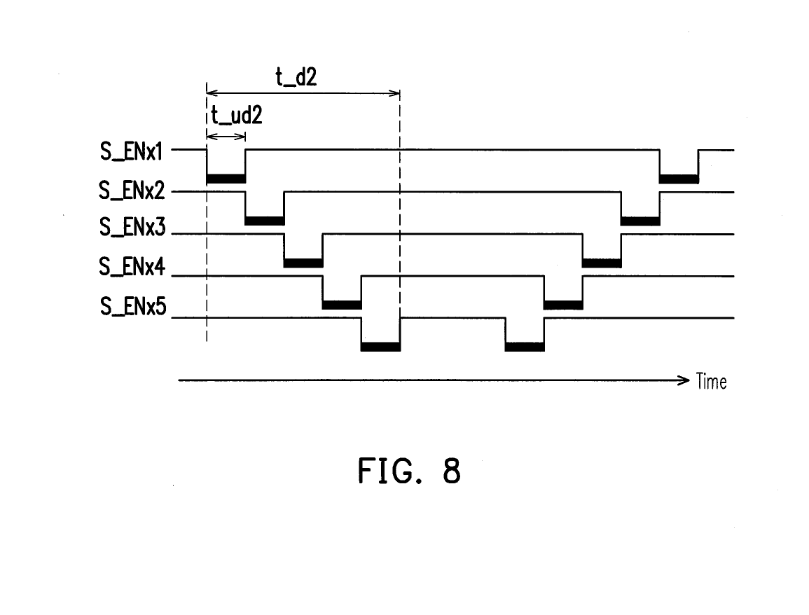

According to the circuit configuration of the delay unit sets 214xt and 214xr, the waveform of the enable signals S_ENx1 to S_ENx5 are schematically illustrated in FIG. 8. With reference to FIG. 7 and FIG. 8, the delay units DUx1t to DUx5t and DUx1r to DUx5r are triggered in sequence when the enable signals S_ENx1 to S_ENx5 outputted from the previous delay units DUx1t to DUx5t and DUx1r to DUx5r are converted to the high level according to the synchronous signal S_synx. Take the delay unit set 214xt for example, the delay unit DUx1t outputs the enable signal S_ENx1 with a low level at the beginning of a sensing period according to the synchronous signal S_synx, and converts the enable signal S_ENx1 to a high level after the unit delay time t_ud2 during the sensing period. Herein, the delay unit DUx2t outputs the enable signal S_ENx2 with the low level in response to the conversion of the enable signal S_ENx1, and similarly converts the enable signal S_ENx2 to the high level after the unit delay time t_ud2 during the sensing period. The rest of delay units DUx3t to DUx5t sequentially output the enable signals S_ENx3 to S_ENx5 in the same manner as described above. The last stage delay unit DUx5t feeds the enable signal S_ENx5 back to the input terminal of the first stage delay unit DUx1t via the inverting output terminal when the enable signal S_ENx5 is converted to the low level according to the enable signal S_ENx4 outputted from the previous stage delay unit DUx4t, such that the low level enable signals S_ENx5 to S_ENx1 are sequentially outputted from the delay unit DUx5t to the delay unit DUx1t in the next sensing period and thus enable the corresponding object transmitting-receiving sensing pairs. Therefore, the delay unit sets 214xt and 214xr can enable the corresponding object transmitting-receiving sensing pairs in sequence by the enable signals S_ENx1 to S_ENx5 with the low level during the delay time t_d2, such that the sensing mechanism of time-multiplexed can be implemented, and thus the position of the object on Y-axis in sensing space can be detected.

In the present embodiment, the timing sequence of the enable signal S_ENx1 to S_ENx5 as shown in FIG. 8 is merely exemplary for description. In other embodiment, the object transmitting-receiving sensing pairs can be enabled in different orders by receiving the enable signals S_ENx1 to S_ENx5 with different timing sequences based on the circuit configuration of the corresponding delay unit sets 216xt and 216xr. However, the disclosure is not limited thereto. Furthermore, although the object transmitting-receiving sensing pairs are enabled by the corresponding enable signals S_ENx1 to S_ENx5 with the low level in the present embodiment, the object transmitting-receiving sensing pairs can be enabled by the corresponding enable signals S_ENx1 to S_ENx5 with the high level, and the disclosure is also not limited thereto.

Based on the above description, the timing signals are modulated based on the position in the sensing space in the present embodiment, such that the signals received by the receiving unit have an enough timing difference between each other, and thus the receiving unit can determine whether the continuous touch events are intended to trigger the corresponding operational function continuously. The timing difference can be set as a delay time, such as the delay time t_d1 or t_d2, according to the time needed for moving a user's finger to the next key, such that the erroneous operation which continuously triggers the same position can be solved since each of the object transmitting-receiving sensing pairs triggers the transmission of the sensing signal after delaying a preset delay time.

In addition, since the object transmitting-receiving sensing pairs are enabled in sequence by the time-multiplexed manner, the object sensing signal with the same wavelength, e.g., the object sensing signal S_O, can be applied to each of the object transmitting-receiving sensing pairs for sensing the object, and it may simplify designs of the object sensing module 210.

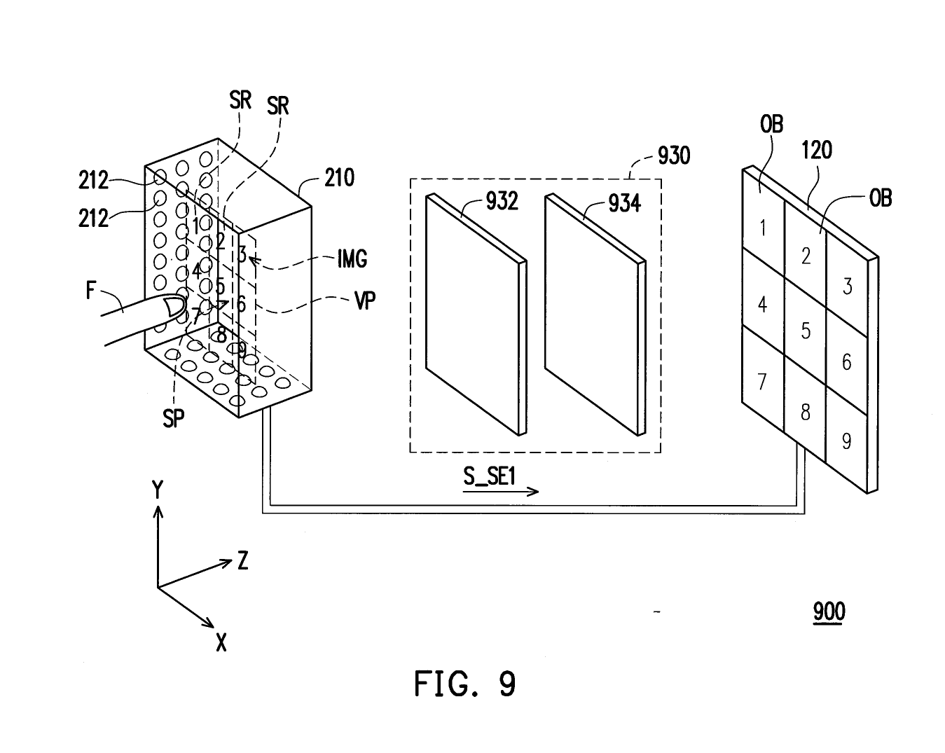

FIG. 9 is a schematic view illustrating a non-touch control system according to another embodiment of the disclosure. With reference to FIG. 9, the non-touch control system 900 comprises an object sensing module 210, a control interface module 120 and an image generating module 930. The object sensing module 210 and the control interface module 120 may be referred to as those described in the previous embodiments and thus will not be further described herein.

Compared with the previous embodiments, the image generating module 930 of the present embodiment further generates an interface image IMG corresponding to the operational interface on the virtual plane VP. The interface image IMG comprises the plural sub-regions SR respectively corresponding to the plural operational blocks OB of the operational interface, such that the corresponding object transmitting-receiving sensing pairs 212 transmit the sensing signal S_SE1 to the control interface module 120 to trigger the corresponding operational function of the control interface module 120 when the specific sub-region SR of the interface image IMG is touched by a user's finger F. Therefore, the user's operational feeling can be enhanced since the user operates the interface image IMG appeared in the sensing space SP.

In the present embodiment, the image generating module 930 comprises a lens film 932 and an image capturing device 934. The image capturing device 934 captures an image corresponding to the operational interface, and generates the flat interface image IMG appeared on the virtual plane VP through the lens film 932. Specifically, the lens film 932 of the present embodiment is disposed in front of the control interface module 120. The lens film 932 is a lens which can transform the flat image into a stereo image such as a Lenticular lens array or a Fresnel lens. For instance, the lens film 932 may be the Fresnel lens if the non-touch control system 900 is applied to the password keypad system, e.g., a keypad of a cash machine. The floating number image of the keypad of the cash machine can only be seen by an operator in a specific viewing angle range when the Fresnel lens is used as the lens film 932, and thus the non-touch control system 900 can prevent the number entered by the operator from being identified by other people. In other words, only the operator can clearly interacts with the operational interface in the non-touch control system 900 with the Fresnel lens of the present embodiment.

In the present embodiment, the lens film 932 and the object sensing module 210 can be integrated with each other. Besides, the lens film 932 of the present embodiment can be constituted by a single lens or plural lens films, and the disclosure is not limited thereto. If the lens film 932 is constituted by the plural lens films, each of the lens films can be set up for corresponding to the images or literals of the operational interface of the control interface module 120. For instance, the lens film 932 may respectively correspond to the number “1” to “9” if the operational interface of the control interface module 120 is the number pad with 3 by 3 grid.

On the other hand, the image capturing device 934 of the present embodiment is disposed between the control interface module 120 and the lens film 932. The image capturing device 934 displays the images or literals corresponding to the operational interface via a display panel of the image capturing device 934 after capturing the images or literals of the operational interface. Herein, a single camera lens or dual camera lens can be applied to the image capturing device 934. In general, the stereo images can be displayed by the image capturing device 934 if the image signals are captured via the dual camera lens image capturing device. The flat images can be displayed by the image capturing device 934 if the image signals are captured via the single camera lens image capturing device. Afterwards, the images displayed on the image capturing device 934 can be imaged as the flat or stereo interface image IMG in the sensing space SP of the object sensing module 210 after the images pass through the lens film 932.

In details, the image capturing device 934 displays the images or literals corresponding to the operational interface, i.e., the two dimensional (2D) image, after capturing the images or literals corresponding to the operational interface if the image capturing device 934 is an image capturing device with the single camera lens. A user can feel the flat interface image IMG is appeared and floated on the virtual plane VP when watching the flat image displayed by the image capturing device 934 through the lens film 932. The image capturing device 934 displays the images or literals corresponding to the operational interface, i.e., the three dimensional (3D) image, after capturing the images or literals corresponding to the operational interface if the image capturing device 934 is an image capturing device with the dual camera lens. A user can feel the stereo interface image IMG is appeared and floated on the virtual plane VP when watching the flat image displayed by the image capturing device 934 through the lens film 932.

Besides, the image capturing device 934 can be a fixed image capturing device or a portable image capturing device. The portable image capturing device for example is a mobile phone with the image capturing function, a laptop, or a tablet computer. For instance, when a user enters an elevator with the portable image capturing device 934, e.g., the mobile phone, the user can capture the operational image of the control interface module, e.g., the elevator buttons, by the image capturing function of the mobile phone. The stereoscopic and floated image of the elevator buttons can be appeared in the sensing space SP of the object sensing module 210 after passing through the lens film 932, such that the non-touch operation can be performed by the user in the sensing space SP of the object sensing module 210.

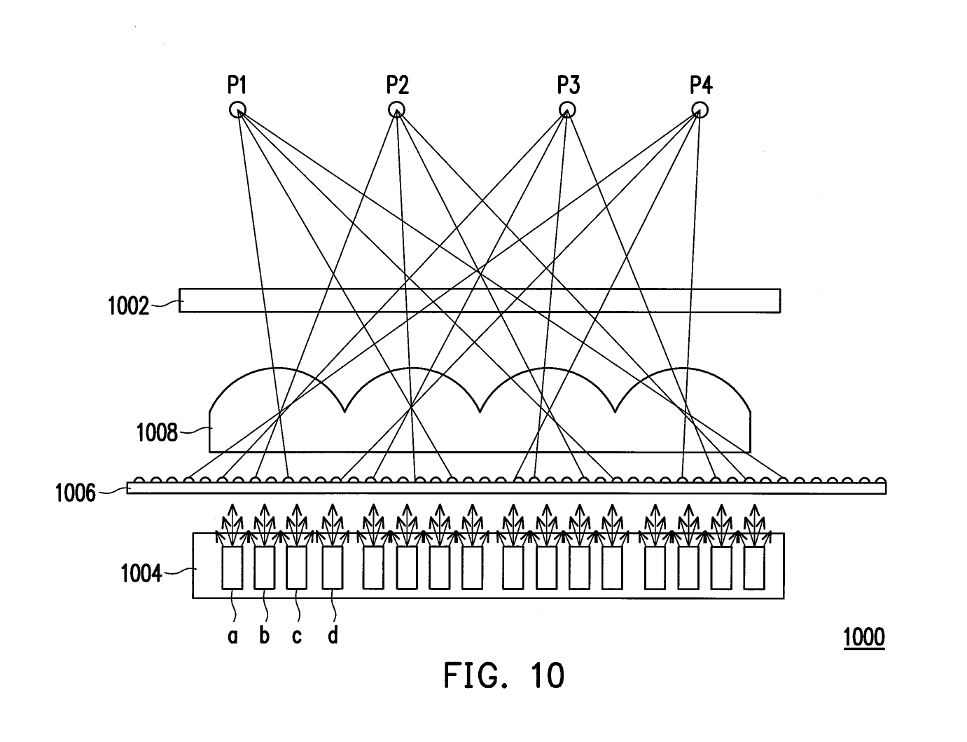

The image generating module 930 can further comprise a multi-view image device 1000 as shown in FIG. 10. The multi-view image device 1000 comprises a display panel 1002 and a light source module 1004. The light source module 1004 comprises a plurality of light bars, e.g., the light bars a, b, c and d. The light bars are lighted in sequence such that a parallax image is displayed on the display panel 1002 for generating a stereoscopic multi-view interface image. Take the elevator buttons module as the control interface module 120 for example, since the elevator is usually used together by many people, the multi-view image device 1000 can be applied to the image capturing device 934, such that the literals or images corresponding to the operational interface can be displayed in multi-view. Therefore, the people standing on the different position in the elevator can see the stereoscopic multi-view interface image corresponding to the operational interface, and thus the non-touch operation performed by plural users simultaneously is available.

Specifically, the light emitted from the light bars a, b, c and d of the light source module 1004 are respectively provided to users at the positions P1 to P4 for viewing the image on the display panel 1002. Therefore, according to the configuration of the light bars, e.g., the light bars a, b, c and d, an optical film 1006 and a lens group 1008, the users at the position P1 to P4 can feel the stereo image with depth even without wearing glasses. In details, the multi-view image device as shown in FIG. 10 rapidly provides plural sets of images with different timing during the persistence of vision of human eyes, such that the illusions generated by human eyes are combined into a complete image and thus the visual effects of full-resolution can be implemented. Since the display frequency is fast enough, and all of the multi-view images are displayed during a non-flicker frequency period, e.g., 60 Hz, the image flicker does not occur. For instance, in the present embodiment, a screen is divided into four sights respectively corresponding to the positions P1 to P4 since the light source module 1004 is directionally driven in sequence with a frequency of 240 Hz in which the driving time of each of sights is 1/240s. As mentioned above, the elements switching between a transparent state and a scattering state can be applied to the light bars, e.g., the light bars a, b, c and d, of the light source module 1004. Therefore, the light source module 1004 can be electrically controlled, and thus the light bars form the transparent state and the scattering state during the different timing sequence and can operate in a time-multiplexed mode or a complex-multiplexed mode. From another perspective, the light source module 1004 can operate in a spatial-multiplexed mode if a part of the light bars are maintained at the scattering state and does not change over time. In other words, the active back light module comprising the light bars can operate in the time-multiplexed mode, complex-multiplexed mode or spatial-multiplexed mode. Besides, each of the light bars, e.g., the light bars a, b, c and d, of the light source module 1004 can be constituted by a light-emitting unit, such as light emitting diode (LED) or organic light emitting diode (OLED), and the disclosure is not limited thereto.

To sum up, the disclosure introduces a non-touch control system. The non-touch control system can provide an operation manner without contacting for operating and controlling a key system, and therefore wastages and pollutions of the key system due to contacting can be avoided. In addition, the non-touch control system further provides a sensing mechanism which can prevent the key system from being inadvertently touched and thus the operational accuracy of the key system can be enhanced.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A non-touch control system, comprising:
an object sensing module comprising a plurality of object transmitting-receiving sensing pairs arranged along a plurality of different directions to define a sensing space, wherein the sensing space comprises a virtual plane, and the object sensing module is configured to sense an object which enters the sensing space and determine whether the object touches the virtual plane; and
a control interface module electrically connected to the object sensing module and configured to provide an operational interface, wherein the virtual plane comprises a plurality sub-regions, the sub-regions are respectively corresponding to a plurality of operational blocks of the operational interface,
wherein when the object touches one of the sub-regions, the object transmitting-receiving sensing pairs corresponding to the sub-region being touched transmits a first sensing signal to the control interface module after a delay time, such that the control interface module executes an operational function of the operational block corresponding to the sub-region being touched.

2. The non-touch control system as recited in claim 1, wherein when the object simultaneously touches the adjacent sub-regions, each of the object transmitting-receiving sensing pairs corresponding to the sub-regions being touched prohibits the first sensing signal from being transmitted to the control interface module.

3. The non-touch control system as recited in claim 1, wherein each of the object transmitting-receiving sensing pairs comprises:
a transmitting module configured to transmit an object sensing signal; and
a receiving module corresponding to the transmitting module and configured to output the first sensing signal according to the object sensing signal, wherein the receiving module comprises:
a receiving unit receiving the object sensing signal and outputting a touch signal accordingly; and
a comparing unit electrically connected to the receiving unit and the receiving units of the adjacent receiving modules for comparing the touch signal outputted from the receiving unit and the touch signals outputted from the receiving units of the adjacent receiving modules and generating the first sensing signal accordingly.

4. The non-touch control system as recited in claim 3, wherein the receiving unit outputs the disabled touch signal when the receiving unit receives the object sensing signal transmitted from the corresponding transmitting module, and the receiving unit outputs the enabled touch signal when the receiving unit does not receive the object sensing signal transmitted from the corresponding transmitting module.

5. The non-touch control system as recited in claim 4, wherein the comparing unit outputs the first sensing signal when the comparing unit determines the touch signal outputted from the receiving unit is enabled and the touch signals outputted from the receiving units of the adjacent object transmitting-receiving sensing pairs are disabled, and the comparing unit does not output the first sensing signal when the comparing unit determines the touch signals outputted from the receiving unit and the receiving units of the adjacent object transmitting-receiving sensing pairs are enabled.

6. The non-touch control system as recited in claim 1, wherein the object sensing module further comprises:
a plurality of delay unit sets respectively electrically connected to the object transmitting-receiving sensing pairs for delaying signal transmission of the object transmitting-receiving sensing pairs; and
a plurality of synchronous processing units respectively electrically connected to the delay unit sets corresponding to the object transmitting-receiving sensing pairs arranged along the same direction, and the synchronous processing units configured to synchronously control each of the delay unit sets to set the delay time which delays the transmission of the first sensing signal of each of the object transmitting-receiving sensing pairs.

7. The non-touch control system as recited in claim 6, wherein the delay unit sets are controlled by the corresponding synchronous processing units to enable the corresponding object transmitting-receiving sensing pairs in sequence during the delay time, such that the object transmitting-receiving sensing pairs corresponding to the sub-region being touched transmit the first sensing signal to the control interface module after the delay time.

8. The non-touch control system as recited in claim 1, wherein the control interface module comprises a flat panel display configured to display a flat image corresponding to the operational interface.

9. The non-touch control system as recited in claim 8, wherein the flat panel display comprises a self-illuminating display panel.

10. The non-touch control system as recited in claim 8, wherein the flat panel display comprises a non-self-illuminating display panel and a back light module.

11. The non-touch control system as recited in claim 1, wherein the control interface module comprises a light source and a transparent mask, the light source projects an image corresponding to the operational interface through the transparent mask.

12. The non-touch control system as recited in claim 1, wherein the control interface module comprises a stereo display configured to display a stereo image corresponding to the operational interface and appeared in the sensing space.

13. The non-touch control system as recited in claim 12, wherein the stereo display comprises a display panel, a lens film and a plurality of light bars, wherein the light bars are lighted in sequence such that a parallax image is displayed on the display panel through the lens film for generating the stereo image with multi-view.

14. The non-touch control system as recited in claim 1, wherein the object sensing module is electrically connected to the control interface module through one of a universal serial bus (USB) transmitting apparatus, a Bluetooth transmitting apparatus and a radio frequency identification (RFID) transmitting apparatus.

15. A non-touch control system, comprising:
an object sensing module comprising a plurality of object transmitting-receiving sensing pairs set along a plurality of directions to define a sensing space, wherein the sensing space comprises a virtual plane, the object sensing module is configured to sense an object which enters the sensing space and determines whether the object touches the virtual plane;
a control interface module electrically connected to the object sensing module for providing a operational interface; and
an image generating module configured to generate a interface image corresponding to the operational interface on the virtual plane, wherein the interface image comprises a plurality of sub-regions, the sub-regions are respectively corresponding to a plurality of operational blocks of the operational interface,
wherein when the object touches one of the sub-regions, the object transmitting-receiving sensing pair corresponding to the sub-region being touched transmits a first sensing signal to the control interface module after a delay time for executing a operational function of the operational block corresponding to the sub-region being touched.

16. The non-touch control system as recited in claim 15, wherein when the object touches at least two of the adjacent sub-regions simultaneously, each of the object transmitting-receiving sensing pairs corresponding to the sub-regions being touched suspend the first sensing signal transmitting to the control interface module.

17. The non-touch control system as recited in claim 15, wherein each of the object transmitting-receiving sensing pairs comprises:
an transmitting module configured to emit an object sensing signal; and
a receiving module corresponding to the transmitting module configured to output the first sensing signal according to the object sensing signal, wherein the receiving module comprises:
a receiving unit, receiving the object sensing signal and outputting a touch signal accordingly; and
a comparing unit electrically connected to the receiving unit and the receiving units of the adjacent receiving modules for generating the first sensing signal accordingly.

18. The non-touch control system as recited in claim 17, wherein the receiving unit outputs the disabled touch signal when receives the object sensing signal transmitted from the corresponding transmitting module, and outputs the enabled touch signal when not receives the object sensing signal transmitted from the corresponding transmitting module.

19. The non-touch control system as recited in claim 18, wherein the comparing unit outputs the first sensing signal when determines the touch signal outputted from the receiving unit is enabled and the touch signals outputted from the receiving units of the adjacent object transmitting-receiving sensing pairs are disabled; and the comparing unit suspends to output the first sensing signal when determines the touch signal outputted from the receiving unit and the receiving units of the adjacent object transmitting-receiving sensing pairs are enabled.

20. The non-touch control system as recited in claim 15, wherein the object sensing module further comprises:
a plurality of delay unit sets respectively electrically connected to the object transmitting-receiving sensing pairs for delaying signal transmission of the object transmitting-receiving sensing pairs; and
a plurality of synchronous processing units respectively electrically connected to the delay unit sets corresponding to the object transmitting-receiving sensing pairs set along the same direction for controlling each of the delay unit sets synchronously to set the delay time which delays the transmission of the first sensing signal of each of the object transmitting-receiving sensing pairs.

21. The non-touch control system as recited in claim 20, wherein the delay unit sets are controlled by the corresponding synchronous processing units to enable the corresponding object transmitting-receiving sensing pairs in sequence during the delay time, such that the object transmitting-receiving sensing pair corresponding to the sub-region being touched transmits the first sensing signal to the control interface module after the delay time.

22. The non-touch control system as recited in claim 15, wherein the image generating module comprises:
a lens film; and
an image capturing device, wherein the image capturing device captures an image corresponding to the operational interface, and generates the flat interface image appeared on the virtual plane through the lens film.

23. The non-touch control system as recited in claim 22, wherein the image generating module further comprises:
a multi-view image device configured to convert the interface image into a multi-view interface image.

24. The non-touch control system as recited in claim 23, wherein the multi-view image device comprises:
a display panel configured to display the image capturing by the image capturing device; and
a light source module comprising a plurality of light bars, wherein the light bars are lighted in sequence such that a parallax image is displayed on the display panel for generating the multi-view interface image.

25. The non-touch control system as recited in claim 15, wherein the image generating module is a portable image generating module.

26. The non-touch control system as recited in claim 15, wherein the control interface module comprises a flat panel display configured to display a flat image corresponding to the operational interface.

27. The non-touch control system as recited in claim 26, wherein the flat panel display comprises a self-illuminating display panel.

28. The non-touch control system as recited in claim 26, wherein the flat panel display comprises a non-self-illuminating display panel and a back light module.

29. The non-touch control system as recited in claim 15, wherein the control interface module comprises a light source and a transparent mask, the light source projects an image corresponding to the operational interface through the transparent mask.
